(19) United States
(12) Patent Application Publication
(10) Pub. No.: US 2005/0120471 A1
(43) Pub. Date: Jun. 9, 2005

(54) Toilet system attached a multi-purpose hand held water sprayer

(76) Inventor: Howard Tak Su Lim, Downey, CA (US)

Correspondence Address: HOWARD TAK SU LIM, 12210 RIVES AVENUE, DOWNEY, CA, 90242, US

(21) Appl. No.: 11/026,671

(22) Filed: Dec. 31, 2004

Related U.S. Application Data
(63) Continuation-in-part of application No. 10/983,552, filed on Nov. 8, 2004.
Application No. 10/983,552 is a continuation-in-part of application No. 10/751,546, filed on Jan. 5, 2004.
Application No. 10/751,546 is a continuation-in-part of application No. 10/731,180, filed on Dec. 9, 2003.

(51) Int. Cl. A61H 35/00

(52) U.S. Cl. 4/448

(57) ABSTRACT

The invention relates to the new features for the earlier applications of toilet system attached a multi-purpose hand held water sprayer affording personal and environmental hygiene. The sprayer that delivers tempered water includes the lock elements on the components to secure connection, various types of spray tip cap for the use of general and medical purposes, an injection apparatus to supply external fluid, a fortified flexible hose, a water hammer arrester or air chamber to reduce water pressure shock, a water heater, a valve to control water flow, a mixing valve, check valves for the mixing valve to stop in reverse flow, a water pressure regulator with a pressure meter, a return line with a check valve for guarding against hot water spike, a thermometer at the outlet, a holder for placement of the sprayer, and various types of valves and sources for the hot and cold water supply. The new features also include the fortified flexible hose having the rollup attachment of middle layers over the flange for reinforcement.

### RELATED APPLICATIONS

This application is continuation-in-part (CIP) of prior U.S. patent application Ser. No. 10/983,552 applied on Nov. 8, 2004, which was a CIP of Ser. No. 10/751,546 applied on Jan. 5, 2004, wherein the application Ser. No. 10/751,546 was a CIP of Ser. No. 10/731,180 applied on Dec. 9, 2003, which are fully incorporated herein.

### BACKGROUND OF THE INVENTION

1. Field of Invention

This invention relates to a toilet system attached a multi-purpose hand held water spraying apparatus, engaging in delivering instant water supply for personal and environmental hygiene.

2. Description of Related Art

The prior application has been added and changed with new features to be adapted to the different environments and usages. The multi-purpose hand held water sprayer in the present invention, namely a “sprayer’, has three components: a controller, an extension bar, and a spray tip to deliver different types of water spray. The female and male couplers of the components are linked using quick connection, wherein the male couplers carrying a multiple O-rings are secured to the female couplers. However, the quick connection may easily be disconnected by the high water pressure or any other strong pulling forces. The lock elements are provided on the couplers to prevent easy disengagement while in use. Also, the various types of caps are presented for the spray tip to supply multiple patterns of the water spray for the use of the general and medical purposes. Besides, the injection apparatus is provided to supply the water sprayer with external soap or medicine fluid. The medical purposes would be for the use of douche or enema system with or without the injection apparatus.

The earlier application has presented the triple or more layered fortified flexible hose which is composed of a smaller inner tube enclosed by the middle layers of the preferably braided metal mesh elements for reinforcement and an outer layer of the exterior decorative tube. The current invention includes the fortified flexible hose having the rollup attachment of the triple or more layered hose to the coupling sleeve for additional reinforcement of the connection. The rollup attachment affords more length for movement of the middle layers and thicker diameter for clamping with the flanges, enabling to hold continuous high water pressures for water supply in remote area.

The water hammer is the sound of moving water having the sudden change in water velocity by the closing of the valve. It occurs when a transfer system is quickly started or stopped. The inertial force of the water is transferred from the water to the pipe and then into the plumbing fixtures of the home. It causes problems such as loud noise throughout the plumbing and destructiveness of joints and fittings, which can be controlled by the installation of water hammer arrestor or air chamber, or both. The water hammer arrestor is a sealed unit that contains a spring and a waterproof air bladder to absorb the inertial force of the moving water. The air chambers are vertical sections of pipes with caps on the ends that are attached with T-adapters to the existing lines near the shut-off valves. The water hammer arrestor or the air chamber is provided in the invention to reduce the problems, if the water hammer occurs.

The earlier application has introduced the mixing valve to supply tempered water at the outlet was not implied the check valves at both inlets to stop the reverse flow of water. Many mixing valves contain the built-in check valves, but there are some mixing valves that do not have them. The external check valves are introduced in the current application at the inlets of those mixing valves that do not have them. The various types of sources including the water heater and connections are presented in order to supply the tempered water. In addition to the T-adapter assembly in earlier application, there are different types of valves are introduced for water supply by adding another valve onto the existing valve or replacing the old one with a valve having dual outlets. The dual outlets of the valve would be controlled by a single knob or dual individual knobs. The tempered water may be obtained from a faucet of the sink near the toilet system or from the valve for the hot water source under the sink by using a mixing valve having built-in check valves. Therefore, the current invention illustrates some examples of the various types of components and connections to supply tempered water for the sprayer.

### SUMMARY OF THE INVENTION

The present invention includes the lock elements of the components having a key element on the male coupler of the components and a recess element on the female coupler as the counterpart. The key element on the male coupler is inserted to the recess element on the female coupler and rotated to be locked each other, reinforcing the connection of two components. The various sizes and shapes of the caps for the spray tip are provided to offer many patterns of water spray for various applications. The straight water spray can be applied on a limited area and the radial spray is for wide region coverage. The elongated caps having various shapes of bodies and holes can be applied for the douche or enema system with a removable protective shield at the base. The injection apparatus connected to the sprayer is for addition of the external soap or medicine fluid to water spray, offering more personal or environmental hygienic features. The apparatus has a main body for connecting the water channel and an auxiliary body with a control valve for injecting the external fluid. The main body and the auxiliary body contain the check valves to stop the reverse flow and the couplers with seals for connection. The sprayer is connected to the three or more layered fortified flexible hose that has the rollup attachment of the reinforcement middle layers against the coupling sleeve. The middle layers are preferably braided metal mesh and their end parts are rolled over the edge of the outer ornamental layer to strengthen the attachment. The filter as an elective element is added to the other end of the flexible hose to eliminate impurity in the water. The valve is connected to the filter for regulating and turning off the water flow. The valve is then connected to a water hammer arrester or an air chamber to avoid situations that create water hammer due to the quick closing valve of the controller.

The water heater is employed to supply hot water with a control valve connected to its inlet line. The water heater having a storage tank that contains the hot water may use a mixing valve preferably the anti-scald mixing valve to supply the tempered water. There is a tankless water heater that heats water to the preset temperature for use, which may not require the mixing valve. The mixing valve has a control knob to adjust the outlet temperature by mixing the hot and cold water. The water temperature at the outlet of the mixing valve can be measured by the thermometer located at the T-adapter. The inlet of the T-adapter is connected to the outlet of the mixing valve. One outlet of the T-adapter is for connecting to the water hammer arrestor or the air chamber and the other outlet is for the return line. The return line is for guarding against the hot water spike delivered from the water heater and requires a check valve to stop the reverse flow. The water pressure regulator with water pressure gauge assures the proper water pressures for water supply to the system.

The multiple types of valves are presented for water supply in addition to the T-adapter with coupling adapters. One type is adding an external valve to the existing valve to obtain the outlet for the water supply. Other type is replacing the existing valve having single outlet with the one having dual outlets. The valve having dual outlets can be controlled by a single knob simultaneously or by dual knobs individually to control the flow of water. The outlet obtained from one of the various types of valves can be connected to the inlet of the water heater with or without an additional valve. The outlet of the water heater is then connected to the fortified flexible hose for use of the tempered water. This type of connection simplifies the installation of the water heater, but may require a certain type of safety device at the outlet such as a thermostatic switch. The tempered water can be obtained from a faucet on the sink having the hot and cold water provided near the toilet, which may be for temporary use and require the adapter for coupling of the fortified flexible hose to the outlet of the faucet. It can also be obtained from the hot water source under the sink by adapting one of the multiple types of valves presented in the above, which may require the mixing valve with the built-in check valves at the inlets and a valve to control the flow.

### BRIEF DESCRIPTION OF THE DRAWINGS

FIG. 1 is a perspective view showing the toilet system attached a multi-purpose hand held water sprayer having a water heater to deliver tempered water.

FIG. 2 is an exploded perspective view of the components of the sprayer having the lock elements on the couplers of the controller, the extension bar, and the spray tip.

FIG. 2A is a perspective enlarged view of the key element on the male coupler taken on the line 2A-2A of FIG. 2.

FIG. 2B is a perspective enlarged view of the female recess element on the female coupler as the counterpart of the male coupler taken on the line 2B-2B of FIG. 2.

FIG. 2C is a side view of the cap for the spray tip having the straight openings for the straight water spray to apply limited area.

FIG. 2D is a side view of the cap for the spray tip having the radial openings for the radial water spray to apply broad area.

FIG. 2E is a side sectional view of the cap for the spray tip having the openings around the elongated separable body from the base and the protective shield secured by the fastening element.

FIG. 2F is a side view of the cap for the spray tip having the opening at the end of the elongated separable body from the base and the protective shield secured by the fastening element.

FIG. 3 is a perspective enlarged view of the injection apparatus taken from the sector A of FIG. 1.

FIG. 3A is a sectional view the injection apparatus taken on the line 3A-3A of FIG. 3.

FIG. 4 a perspective view of the fortified flexible plumbing hose having two connecting couplers at both ends and a filter above one coupler.

FIG. 4A is a structural view of the flexible hose taken on the line 4-4 of FIG. 4 having a small inner hose enclosed with one or more layers of a braided metal mesh and then with an outer flexible ornamental metal tube.

FIG. 4B is a perspective view of the end of the flexible hose having a connecting sleeve and a clamped flange with a connecting coupler lowered down.

FIG. 4C is an enlarged section view of the end of the flexible hose taken on the line 4B-4B of FIG. 4B.

FIG. 5 is an exploded perspective view of the water heater and the plumbing fixtures for connection.

FIG. 6 is an exploded perspective view of the valve having a T-adapter with coupling adapters and the water heater connected with an additional valve and couplers for tempered water supply.

FIG. 7 is an exploded perspective view of the external valve added to the existing valve and the water heater connected with an additional valve and couplers for tempered water supply.

FIG. 7A is an exploded perspective view of the valve having dual outlets and a single control knob.

FIG. 8 is an exploded perspective view of the valve having dual outlets and dual control knobs and the water heater connected with couplers for tempered water supply.

FIG. 9 is a perspective view of the present invention with the sprayer having the fortified flexible hose connected to the faucet on the sink with the coupling adapter.

FIG. 10 is a perspective view of the present invention with the hot water source under the sink connected to the sprayer through the adapters, the mixing valve having the built-in check valves, the valves, and the fortified flexible hose.

### DESCRIPTION OF THE PREFERRED EMBODIMENTS

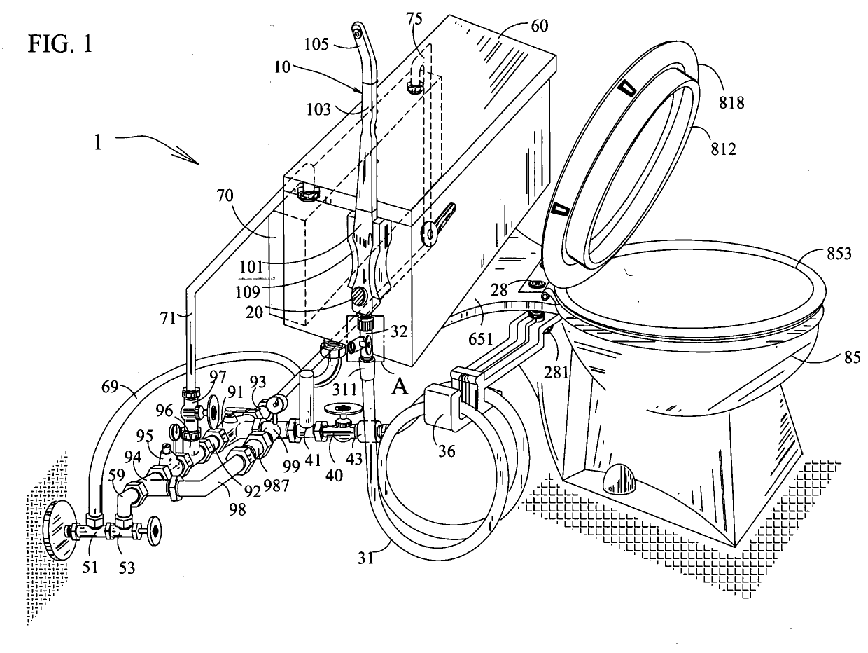

Reference is now made in detail to the present invention, examples of which are illustrated in the accompanying drawings wherein reference numerals having the same first two digits indicate related elements, such as 10 and 101. The numerals having the same first three digits indicate same components with different elements, such as 101 and 1019. General structures of the present invention will be described following by details and the function of components. Referring to FIG. 1, a perspective view of the present invention, a toilet system attached a multi-purpose hand held water sprayer, is shown and indicated the number 1. The system is generally composed of a hand held water sprayer 10, namely “sprayer”; an injection apparatus 32; a fortified flexible hose 31; a filter 43; a valve 40; a water hammer arrester or air chamber 41; a mixing valve 91; a check valve 92 for the cold water inlet of the mixing valve 91, a check valve 93 for the hot water inlet of the mixing valve 91; a T-adapter 99 with a thermometer; a check valve 987 for the return line; a return line 98; a water heater 70; a hot water supply line 75 from the heater; a cold water inlet line 71 for the water heater 70; a valve 97 for the water heater 70; a T-adapter 96 for the water heater 70 and the mixing valve 91; a water pressure regulator 95 with a pressure gauge; a T-adapter 94 for the water pressure regulator 95 and the return line 98; an elbow 59; and a coupling valve 53 added to the existing angle stop valve 51; a hose rack 36 mounted on the toilet seat fastener 28 using a nut 281; a holder 109 for the sprayer 10; a water splash guard 812 for the toilet seat 818. More details regarding the present invention are described in the following.

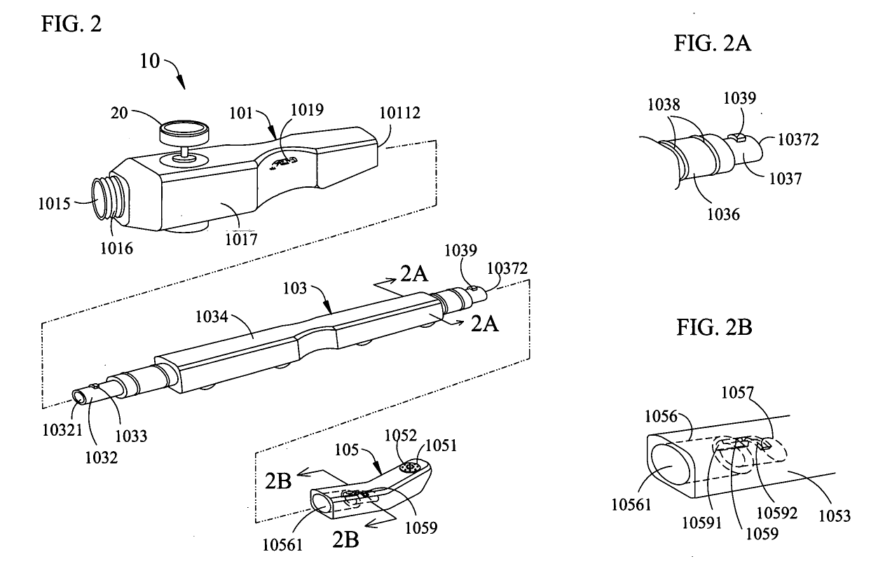

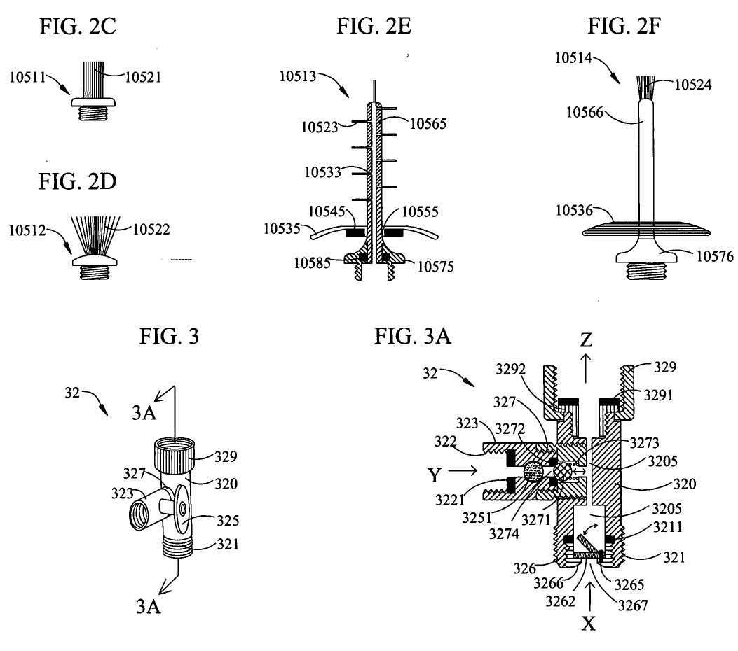

The sprayer 10 in FIG. 1, comprising a controller 101 with a pushbutton 20 and an extension bar 103 with a spray tip 105, is connected to a flexible hose 31 with means to secure 1016 of FIG. 2 through the injection apparatus 32 of FIG. 1. The extension bar 103 in FIG. 2 includes a channel in the body 1034 connected from the inlet 10321 to the outlet 10372, wherein the inlet and the outlet have two stages of male couplers to secure to the matching female couplers. The inlet 10321 in FIG. 2 of the extension bar 103 is connected to the outlet 10112 of the controller 101 and the outlet 10372 of the extension bar 103 is connected to the inlet 10561 of the spray tip 105 preferably but not limited by means of the quick connection. The first stage 1036 in FIG. 2A of the male coupler having a large diameter contains a multiple grooves and O-rings 1038 for seals and link friction against the matching female coupler 1056 in FIG. 2B. The second stage 1037 in FIG. 2A is implemented as for guidance of the connection of two components, whereon the key element 1039 is placed as for lock against the female counterpart element 1059 in FIG. 2B. The female counterpart element 1059 in FIG. 2B has a longitudinal recess 10591 for insertion of the key element 1039 and a cross path 10592 for rotation to lock. The same features are located on the other end of the extension bar, where the key element 1033 on the second stage 1032 is placed into the matching female coupler 1019 and rotated for lock. The key element on the male coupler can take a loop around the surface and its female coupler can take a matching groove as for the counterpart to push to lock. The key element and the match female coupler can be varied to achieve the lock for connection without changing the scope of the invention.

The sprayer tip 105 in FIG. 2 includes different types of cap 1051 for various applications, wherein the cap 1051 includes a multiple small openings 1052 to supply various patterns of water spray. Besides to the cap having larger openings for delivering more water, the cap 10511 in FIG. 2C having the straight openings supplies the water spray 10521 in the straight direction to spray limited area, wherein the top surface of the cap may take the straight line to assist straight spray. The cap 10512 in FIG. 2D having radial openings supplies the water spray 10522 in radial direction to spray a wide range of area, wherein the top surface of the cap may take a curved line to assist radial spray. The cap 10513 in FIG. 2E having openings 10533 around the elongated body 10565 supplies water spray 10523 in various directions, wherein the body may hold a removable or non-removable protective shield 10535 with the edge 10555 secured by the fastening element 10545 near the base 10575. The elongated body 10565 of the cap 10513 can be separable from the base 10575 for quick connection, requiring means to secure for a male coupler and the matching female coupler with seals 10585. The cap 10514 in FIG. 2F having openings at the end of the elongated body 10566 may supply water spray 10524 in a straight or radial mode, wherein the body may take the same features of protective shield 10536, the quick separable body 10566, and the base 10576 as in FIG. 2E. The sprayer with the cap having the elongated body can be applied for the douche and enema system to achieve the personal or medical desired results.

The injection apparatus 32 in FIG. 1 is preferably located between the sprayer 10 and the fortified flexible hose 31 to inject any external fluid such as soap or medicine into the water spray. The injection apparatus 32 in FIG. 3 comprises a main body 320 having an inlet 321 and an outlet 329, attached with an injector element 323 with a check valve 327 and a control valve 325. The main body 320 in FIG. 3A comprises the inlet coupler 321, the outlet coupler 329, the channel 3205 flowing from X to Z, and the check valve 326 to stop the flow in reverse. The check valve 326 at the inlet comprises a body having means to secure to the main body 320 with the seal 3211, a channel 3267, a flask type entrance 3266 of the channel 3267 to reduce the flow resistance, and a disk 3262 to open and close the channel 3267 which is secured with a fastener 3265. The outlet of the main body 320 contains means to secure including a coupling nut 329 with a flange element 3292 to facilitate connection. The channel 3205 of main body 320 has a narrow passage 3205 located at the outlet of the injector 323 to increase in the speed of the water flow, producing a decrease in pressure explained by the Bernoulli's principle. The decrease in pressure causes in the suction of the fluid from the injector element 323, resulting in mixture with the water flow in the main body 320. The injector element 323 comprises an inlet coupler 322 with the seal 3221, the valve stem 3251 to control the injection flow Y, and a check valve 327 to stop the flow in reverse. The check valve 327 has a body including means to secure, a channel 3274, a ball 3271 with the seat 3272, a spring 3273 to support the ball 3271. The check valves can be changed each other or replaced with the other types of check valves preventing backflow and they can be externally added or built in to the injection apparatus 32.

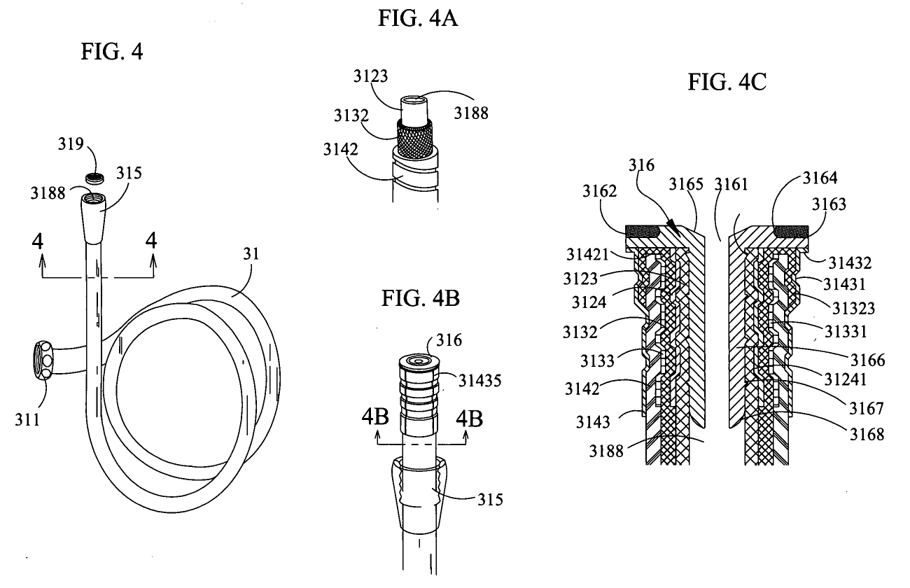

The fortified flexible hose 31 in FIG. 4 having a channel 3188 in the middle includes preferably but not limited a long coupler 315 to be connected to the coupler 1016 of the controller 101 in FIG. 2 and a short coupler 311 to receive the water supply. It utilizes a filter insert 319 in FIG. 4 to eliminate impurities in the water. The fortified flexible hose 31 has the flexible inner hose 3123 in FIG. 4A with a small diameter being wrapped by one or more braided metal mesh elements 3132 for reinforcement. The braided metal mesh elements 3132 is then covered with the outer ornamental hose including but not limited flexible metal tube for the aesthetic appearance and more reinforcement. This minimum of three layered flexible hose 31 has a coupling sleeve 316 in FIG. 4B to retain the coupler 315 for connection at both ends. The coupling sleeve 316 in FIG. 4C comprises an opening 3161 in the middle, a washer 3162, a recess 3163 for placing the washer 3162, a niche 3164 on the recess 3163 for holding the washer 3162, a recessed entrance 3165 for reducing friction of the water flow, a lengthy tubular body 3166 for placement of the end part of the hose, hooks 3167 on the body 3166 for the secure connection, and skew element 3168 at the end of body for easy placement of the inner hose 3123.

The flexible inner hose 3123 is placed into the lengthy tubular body 3166, followed by the inner flange 3124 clamped onto it. The next reinforcement layers including but not limited braided metal mesh element 3132 is placed onto the flange 3124, followed by the next flange 3133 clamped onto it. Again, the next following reinforcement layers including but not limited braided metal mesh elements are placed onto the previous layers or flanges, followed by the next flanges clamped onto them. Finally, the outer ornamental flexible hose 3142 is again placed onto the flange 3133, followed by the outer flange 3143 clamped onto it. This procedure creates the minimum three layers of the fortified flexible hose for the sprayer. The clamping creates the flanges to form a multiple ridges and troughs 31241, 31331, 31431 as shown in FIG. 4C, reinforcing the connection of the hose 33 against the lengthy tubular body 3166 of the coupling sleeve 316. The excess part from the clamping of the flange may also produce a multiple lengthy bulging lines 31435 along the flange surface. The second or further reinforcement layers of metal mesh elements 3132 have the rollup end 31323 in FIG. 4C over the edge 31421 of the outer ornamental flexible hose 3142, reinforcing the attachment by offering more length of the layers for movement and thickness for clamping. The outer flange 3143 has a shoulder 31432 to retain the coupler 315 in FIG. 4B for connection. The flanges except the outer flange 3143 can be excluded for simplified attachment of the hose against the coupling sleeve 316 without the change of the scope of the current invention.

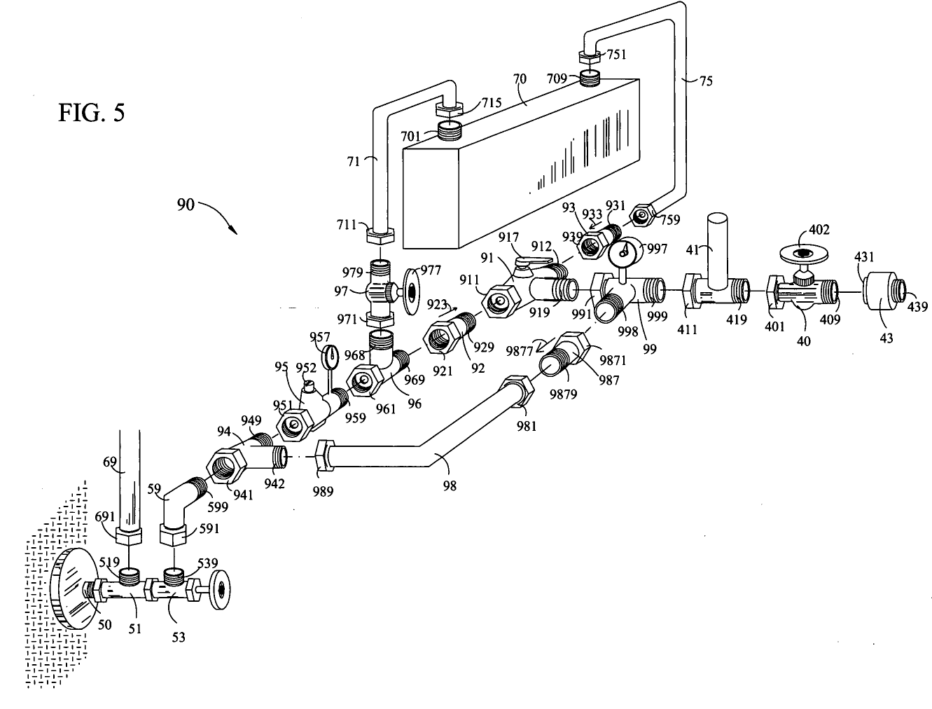

The inlet 311 of the hose 31 in FIG. 4 is further connected to the outlet 439 in FIG. 5 of the filter 43 with means to secure for further eliminating the pollutants in the water. The inlet 431 of the filter 43 in FIG. 5 is connected to the outlet 409 of the valve 40 to get the regulated flow of water. The valve 40 is used for regulating and turning off the water flow with the control knob 402. The inlet 401 of the valve 40 is connected to the outlet 419 of the water hammer arrester 41 or the air chamber with means to secure to reduce or eliminate the situation that water hammer may occur. The water hammer arrester 41 or the air chamber is an optional component and can be installed anywhere near the source. The inlet 411 of the water hammer arrester 41 is connected to one outlet 999 of the T-adapter 99, which contains a thermometer 997 to measure the water temperature. The other outlet 998 of the T-adapter 99 is connected to the inlet 9871 of the check valve 987 as a part of the return line configuration. The hot water in the T-adapter 99 flows back to the cold water inlet line through the check valve 987 and the return line 98, guarding against the unexpected hot water spike. The check valve 987 stops the flow in reverse, allowing the water in the T-adapter 99 flowing in the direction 9877 of the cold water inlet. The inlet 991 of the T-adapter 99 is connected to the outlet 919 of the mixing valve 91 to receive the tempered water.

The mixing valve 91 in FIG. 5 requires the check valves 92, 93 in both inlets 911, 912 to stop the flow in reverse. The inlet 911 of the mixing valve 91 in FIG. 5 is connected to the outlet 929 of check valve 92, wherein the check valve 92 allows the cold water flow in the direction 923 to the mixing valve. The inlet 912 of the mixing valve 91 is also connected to the outlet 939 of the check valve 93, wherein the check valve 93 allows the hot water flow in the direction 933 to the mixing valve 91. However, there are many mixing valves that include the built-in check valves at the inlets, which may not require any external check valves. The mixing valve 91 has a control handle 917 to adjust the temperature of the water at the outlet. There are different types of mixing valves available. The mechanical mixing valve adjusts water flow using a mechanical valve movement to blend hot and cold water. The automatic pressure balancing mixing valve regulates the water flow of the hot and cold water supply lines by sensing changes in water pressure in one line and adjusting water flow in the other supply line accordingly. The thermostatic mixing valve senses the outlet temperature and compensates for fluctuations in incoming hot and cold water temperature to blend hot and cold water producing tempered water. The combined thermostatic and pressure balancing mixing valve senses the outlet temperature and incoming hot and cold water pressure and compensates for fluctuations in incoming hot and cold water temperature and pressures to stabilize the outlet temperature. All of the mixing valves preferably have a thermostatic limit stop feature incorporated so that the valve automatically shuts off the hot water if the cold water supply fails.

The water heater 70 in FIG. 5 is provided to supply hot water to the mixing valve 91 through the check valve 93 and the hot water supply line 75. The outlet 709 of the water heater 70 is connected to the inlet 709 of the hot water supply line 75 and the outlet 759 of the hot water supply line 75 is connected to the inlet 931 of the check valve 93. The inlet 701 of the water heater 70 is connected to the outlet 715 of the cold water supply line 71 and the inlet 711 of the cold water supply line 71 is connected to the outlet 979 of the valve 97, wherein the valve 97 controls the cold water flow to the water heater 70. The one outlet 968 of the T-adapter 96 is connected to the inlet 971 of the valve 97 to supply the cold water to the water heater 70 and the other outlet 969 is connected to the inlet 921 of the check valve 92 to supply cold water to the mixing valve 91. The water pressure regulator 95 is presented to regulate the water pressure to the system and the pressure gauge 957 at the outlet is for measuring the water pressure. The water pressure regulator 95 includes a control element 952 to regulate the pressure for the water supply line. The inlet 951 of the water pressure regulator 95 is connected to the one outlet 949 of the T-adapter 94. The one inlet 942 of the T-adapter 94 is connected to the outlet 989 of the return line 98 and the inlet 981 of the return line 98 is connected to the outlet 9879 of the check valve 987. The return line 98 can be connected to the any part of the inlet cold water supply line. The other inlet 941 of the T-adapter 94 is connected to the outlet 599 of the elbow 59 or any coupling element, whereas the inlet 591 of the elbow 59 is connected to the outlet 539 of the added valve 53 to the existing valve 51. The outlet 529 of the existing valve 52 is for connecting to the existing water supply line 69 to the toilet water tank 60 in FIG. 1.

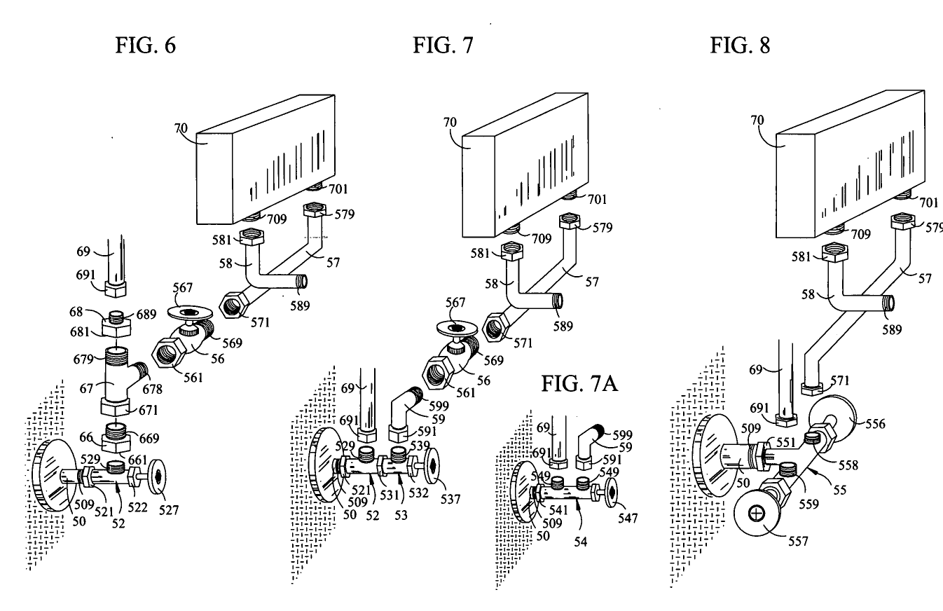

There are different types of components and connections implemented to supply the tempered water, a few types are here presented as for illustrations and more types can be achieved by combining various components and connections without changing the scope of the invention. The T-adapter 67 presented in earlier applications is connected with or without a pair of coupling adapters 66, 68 in FIG. 6 to acquire water from the existing line. The water heater 70 that heats the cold water to the preset temperature level is added with the valve 56 and connectors 57, 58 to supply the tempered water. The outlet 529 in FIG. 6 of the existing valve 52 is connected to the inlet 671 of the T-adapter 67 with or without the coupling adapter 66 for the water supply. If the T-adapter 67 requires the coupling adapter 66 due to the different sizes or threads, the inlet 661 of the coupling adapter 66 is connected to the outlet 529 of the existing valve 52 and the outlet 669 of the coupling adapter 66 is connected to the inlet 671 of the T-adapter 67. The one outlet 679 of the T-adapter 67 is then connected to the inlet 691 of the existing water supply line 69 for toilet water tank with or without the coupling adapter 68. If necessary, the outlet 679 of the T-adapter 67 is connected to the inlet 681 of the coupling adapter 68 and the outlet 689 of the coupling adapter 68 is connected to the inlet 691 of the existing water supply line 69. The other outlet 678 of the T-adapter 67 is connected to the inlet 561 of the valve 56 and the outlet 569 of the valve 56 is connected to the inlet 571 of the water supply line 57, wherein the valve 56 is provided to control the water flow to the water heater 70. The outlet 579 of the water supply line 57 is connected to the inlet 701 of the water heater 70, followed by the outlet 709 of the water heater 70 is connected to the inlet 581 of the elbow 58 or any coupling element. The outlet 589 of the elbow 58 is then connected to the coupler 311 in FIG. 4 of the fortified flexible hose 31 for supplying tempered water to the sprayer.

The external valve 53 in FIG. 7 is added to the existing valve 52 to supply cold water to the water heater for use of the tempered water. The existing control knob 527 in FIG. 6 having a single stem is removed using the valve cover 522 and replaced with the valve 53 having a control knob 537 in FIG. 7 which retains dual stems for the dual outlets 529, 539, wherein the control knob 537 adjusts the water flow of both the outlets 529, 539 at the same time. The outlet 529 of the existing valve 52 is for connection of the inlet 691 of the existing water supply line 69 to the toilet water tank and the outlet 539 of the added external valve 53 is for connecting to the inlet 591 of the elbow 59 or other connector to supply water. The outlet 599 of the elbow 59 is then connected to the inlet 561 of the valve 56 and the outlet 569 of the valve 56 is connected as the same way described in the above. The existing valve 52 in FIG. 6 can be replaced with a valve 54 having two outlets 548, 549 with a single control knob 547 by connecting the outlet 509 in FIG. 7A of the existing water source line 50 to the inlet 541 of the valve 54 as shown in FIG. 7A. The single control knob 547 regulates the water flow at both of the outlets 548, 549 concurrently. The outlet 549 of the valve 54 is for connection of the inlet 691 of the water supply line 69 to the toilet and the outlet 548 is for connection of the elbow 59 or other adaptor to the water heater. The connections at the outlets of the valve or valves can be exchangeable to supply water for the toilet and the water heater.

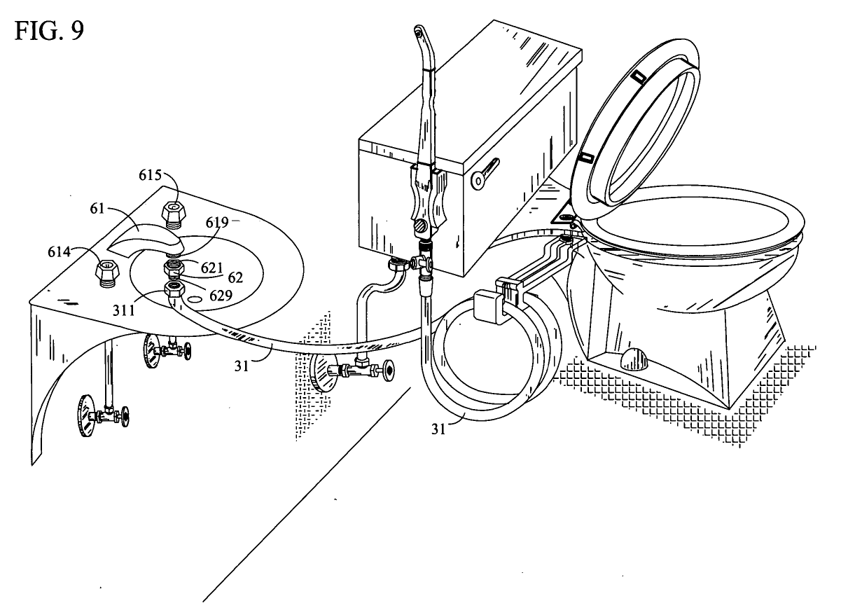

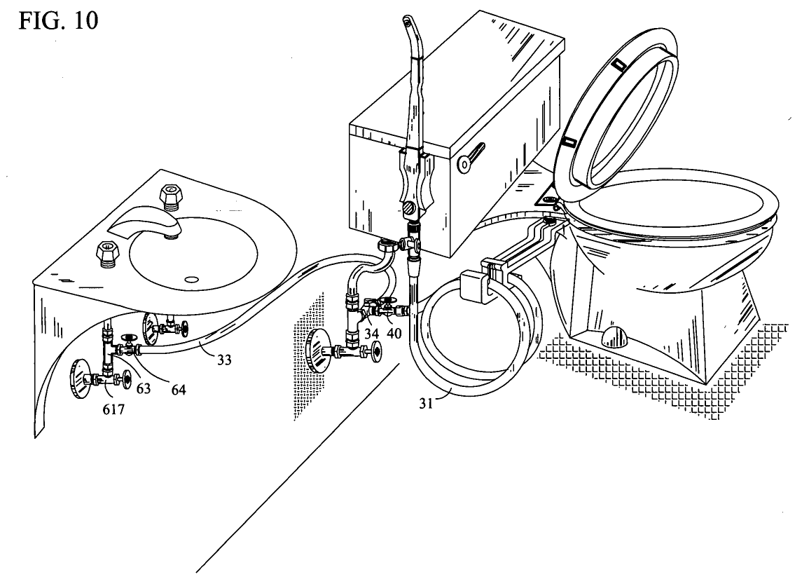

Another type of the valve 55 in FIG. 8 having dual outlets 558, 559 and dual control knobs 556, 557 is introduced to supply cold water to the water heater for use of the tempered water. The valve 55 eliminates the external valve 56 in FIG. 7, simplifying the connections and reducing components. The outlet 509 of the existing water source line 50 is connected to the inlet 551 of the valve 55, wherein the one outlet 559 of the valve 55 is for connection of the inlet 691 of the water supply line 69 and the other outlet 558 is for connection of the inlet 571 of the water supply line 57 for the water heater 70. The outlet 579 of the water supply line 57 is connected to the inlet 701 of the water heater 70, and the outlet 709 of the water heater 70 is connected to the elbow 58 or other adapter to connect to the inlet 311 of the flexible hose 31 in FIG. 4 for supplying tempered water to the sprayer. All of the water heaters in the above preferably contain a thermostatic stop at the outlet for safety.

The faucet 61 on the sink 68 in FIG. 9 may be a good temporary source for use of the tempered water to the sprayer. The faucet 61 has an outlet 619 for the tempered water which is fully adjustable with the control knobs for hot water 614 and cold water 615. It requires a coupling adapter 62 that connects to the fortified flexible hose. The outlet 619 of the faucet 61 is connected to the inlet 621 of the coupling adapter 62 and the outlet 629 of the coupling adapter 62 is connected to the inlet 311 of the fortified flexible hose 31 to supply the tempered water to the sprayer. The valve 617 in FIG. 10 for hot water under the sink 68 is another source to provide tempered water to the sprayer using one type of valves or adapters in the above. The T-adapter 63 with couplings is presented for an example to supply hot water to the mixing valve 34 having built-in check valves through the in-line valve 64. The outlet of the mixing valve 34 is connected to the fortified flexible hose 31 through the control valve 40 to supply tempered water for the sprayer. The various types of valves presented in the above can be utilized to supply hot water with a variety of components and connections.

The hose rack 36 in FIG. 1 is provided for arrangement of the long fortified flexible hose 31 to be installed on a fastener 28 for the seat or the water tank secured on the base 651. The holder 109 in FIG. 1 is for placement of the water sprayer 10 and can be mounted on any flat surface using the tape having adhesive on both sides or applying adhesive agent on the mounting area. The water splash guard 812 in FIG. 1 is located underbody of the toilet seat 81 around the opening in the middle. It protects water escape through the gap between the toilet bowl 85 and the seat 81 while the water sprayer is being used inside the bowl. All of the connections in the above are done with means to secure include but not limited the rotatable female threaded nut and the matching male thread with seals. The rotatable female threaded nut is useful for connection, because it allows one component secured to the other while maintaining the component in any position. The seals include but not limited washers, gaskets, or tapes between the female threaded openings and the male thread for sealing in the connection.

1. Toilet system attached a multi-purpose hand held water sprayer comprises:
a hand held water sprayer including components of a controller, an extension bar, and a spray tip;
a water supply for said sprayer in cold or tempered water;
a male coupler on said components for connection including but not limited two stages of diameters;
a female matching coupler to said male coupler on said components for connection including but not limited two stages of diameters;
a lock element on said coupler as means for lock the connection;
a cap for said spray tip having various types of body for spraying various patterns of water spray;
a holder including a body having an opening for said sprayer and a base for securing and means including but not limited holes for fasteners or flat surfaces for adhesive to be secured to any surface;
an injection apparatus to add the external fluid to the water spray;
a fortified flexible hose connected to said hand held sprayer for the extended water supply from the source;
a filter insert for said flexible hose to remove the contaminated substances in the water;
a hose rack for arrangement of said fortified flexible hose having means to secure to any fasteners on or around the toilet;
an external filter connected to said flexible water for eliminating the pollutants in the water;
a valve connected to said filter for regulating the water flow;
a water hammer arrestor or an air chamber to avoid situations that create water hammer;
a T-adapter connected to said water hammer;
a check valve connected to said T-adapter for return of hot water flow to cold water;
a return line connected to said check valve to guard against hot water spike;
a mixing valve connected to said T-adapter to supply tempered water by mixing hot and cold water delivered from the inlets;
a thermometer on said T-adapter or the outlet of said mixing valve to measure the water temperature;
a check valve for the cold water inlet of said mixing valve;
a check valve for the hot water inlet of said mixing valve;
a water heater to heat water to the preset temperature;
a thermostatic stop built in the outlet of said water heater to stop the flow of hot water above the preset temperature;
a water supply line for the hot water inlet of said mixing valve from the outlet of said water heater;
a valve for said water heater to control the inflow;
a water supply line connected from the inlet of said water heater to said valve;
a T-adapter connected to said valve and to said check valve for the cold water inlet of said mixing valve;
a pressure regulator for said water heater and said mixing valve;
a control element on said pressure regulator to regulate the inlet pressure;
a pressure gauge for said pressure regulator to measure the flow pressure;
a T-adapter connected to said pressure regulator and to said return line;
an elbow or coupler connected to said T-adapter;
a valve for said water supply;
a coupling adapter for said water supply connected to a faucet of sink;
a connection of said flexible water hose with said sprayer to said faucet of sink using said coupling adapter for said water supply;
a connection of said T-adapter or said valve for water supply to hot water source of said sink to supply tempered water through said mixing valve with check valves;
a water splash guard on underbody of toilet seat around the opening to protect water escape through the gap between the toilet seat and the toilet bowl.

2. Toilet system attached a multi-purpose hand held water sprayer according to claim 1 wherein said lock element includes but not limited:
a key element on said male or female coupler including but not limited a bulging or protruding element;
a recess element on said male or female matching coupler as the counterpart of said key element including but not limited a groove element;
an insertion to lock of said key element onto said recess element for lock the connection;
a rotation to lock of said key element onto said recess element for lock the connection;

3. Toilet system attached a multi-purpose hand held water sprayer according to claim 1 wherein said cap for said spray tip comprises:
a body having means to secure;
a channel in said body for delivering water;
an opening on said body connected to said channel for delivering water spray;
a straight opening on said body for delivering straight water spray;
a radial opening on said body for delivering radial water spray;
a flat surface on said body preferably for said straight opening;
a curved surface on said body preferably for said radial opening;
an elongated body of said body having means to secure;
a channel in said elongated body for delivering water;
an opening on said elongated body connected to said channel for delivering water spray around said body;
an opening on said elongated body connected to said channel for delivering water spray on the end of said body;
a protective shield to guard sprayer;
a flange for supporting said protective shield;
a fastener to secure said protective shield with flange on said elongated body;
a base having means to secure to said spray tip and said elongated body for removable feature;
a quick connection of said elongated body to said base for easy plug-in and pull-out;

4. Toilet system attached a multi-purpose hand held water sprayer according to claim 1 wherein said injection apparatus comprises:
a main body for delivering water flow;
an inlet on said main body having means to secure;
an outlet on said main body having means to secure including but not limited a coupling nut;
a flange to secure said coupling nut to said main body;
a channel connected from said inlet to said outlet;
a check valve in said inlet to stop the flow in reverse direction;
an opening for said check valve in said inlet of said main body;
a seal for said check valve for securing to said main body;
a body of said check valve having means to secure;
an opening in said body of check valve;
a flask shape entrance in said opening for lowering flow friction;
a disc in said opening for opening and closing;
a injector element for supplying external fluid;
a body of said injector element;
an inlet on said body having means to secure to an external container having fluid;
an outlet on said body having means to secure to said main body;
a channel connected from said inlet to said outlet;
a stem in said channel to regulate the flow;
a knob on said stem to facilitate to move;
a check valve to stop the flow in reverse direction;
a body for said check valve;
a channel in said body for flow of the fluid;
a ball in said channel for opening and closing;
a seat for said ball to seal said channel for closing;
a spring for said ball to close against said seat;
a smaller channel of said main body than the adjacent channel at the outlet of said injector element to create low pressure for injection of fluid by increasing the speed of water in said smaller channel;

5. Toilet system attached a multi-purpose hand held water sprayer according to claim 1 wherein said fortified flexible hose comprises:
a body composing the sum of three or more layers;
an inner hose element on said body having features of small diameter to offer flexibility and room for next outer layer for reinforcement, composing one layer of said body;
a middle reinforcement element on said body having one or more layers including but not limited braided metal mesh elements to reinforce said inner hose, composing the sum of two or more layers of said boy including said inner hose;
a outer external ornamental element on said body as for the last outer layer including but not limited flexible metal tube to reinforce said inner hose and said middle reinforcement elements, composing the sum of three or more layers of said body including said inner hose element and said middle reinforcement element;
an inlet on said body for receiving the water;
a coupler on said inlet having means to secure including but not limited rotatable female threaded nut with seals;
an outlet on said body for delivering the water;
a coupler on said outlet having means to secure including but not limited rotatable female threaded nut with seals;
a channel in said inner hose element of said body connecting said inlet to said outlet for carrying water;
a coupling sleeve located in said inlet and said outlet;
an attachment of said fortified flexible hose onto said coupling sleeve at said inlet and said outlet.

6. Toilet system attached a multi-purpose hand held water sprayer according to claim 2 wherein said coupling sleeve comprises:
a body having a disk element attached with a lengthy tubular body, wherein said disk element has larger diameter than said lengthy tubular body;
an opening in the middle of said body;
a seal element on said disk element;
a recess on said disk element for said seal element;
a niche on said recess to hold said seal element;
a recessed flask entrance around said opening for reducing friction of the water flow;
a hook on said tubular body to secure connection of said inner hose element without slippage;
a skew element on said tubular element at the end for easy placement of said inner hose element;

7. Toilet system attached a multi-purpose hand held water sprayer according to claim 2 wherein said attachment of said fortified flexible hose onto said coupling sleeve comprises:
a placement of said inner hose element onto said tubular body;
an inner flange on said inner hose element to be clamped;
a placement of middle reinforcement element onto said inner flange or on said inner hose;
a middle flange on said middle reinforcement elements to be clamped;
a multiple of the placements of middle reinforcement elements onto previous said middle reinforcement elements followed by middle flanges on previous said middle reinforcement elements to be clamped;
a placement of said outer external ornamental element onto said middle flanges or on said middle reinforcement elements;
an outer flange on said outer external ornamental element to be clamped;
a rollup attachment of said multiple of said reinforcement elements over the edge of said outer external ornamental element to reinforce attachment including but not limited the configurations of rolling up, wrapping up, folding up, and bending up of the end part of said reinforcement elements;
a shoulder of said outer flange to hold said coupler of said fortified flexible hose;
a ridge on said flanges around said tubular body;
a trough on said flanges between said ridges of said tubular body;
a bulging line placed lengthwise on said flanges across said ridge and said trough;

8. Toilet system attached a multi-purpose hand held water sprayer according to claim 1 wherein said valve for water supply comprises various types including but not limited:
a first type of valve having the T-adapter with coupling to connect to the outlet of the existing valve;
a second type of valve having the external valve with a single outlet added to the existing valve with a single control knob and dual control stems to regulate two outlets simultaneously;
a third type of valve having the valve with dual outlets and a single control knob for controlling the dual outlets simultaneously;
a fourth type of valve having dual outlets and dual control knobs for controlling the dual outlets individually.

9. Toilet system attached a multi-purpose hand held water sprayer according to claim 1 wherein said water heater connected to said valve for said water supply includes:
a control valve connected to the inlet of said water heater for said first, second, or third type of valve;
a supply line for the inlet of said water heater;
a coupler including but not limited an elbow for connection to the inlet coupler of said hose.

10. Toilet system attached a multi-purpose hand held water sprayer according to claim 1 wherein said coupling adapter for water supply connected to a faucet of sink comprises:
a body for coupling said faucet to said flexible water hose;
an inlet on said body having means to secure connected to the outlet of said faucet of sink;
an outlet on said body having means to secure connected to the inlet of said flexible water hose;
a channel connected from said inlet to said outlet;

11. Toilet system attached a multi-purpose hand held water sprayer according to claim 1 wherein said connection employs means to secure include but not limited various types of screw, thread, adhesive, hook, anchors, welding, or any fastening measures for joining one element to the other with or without using lock washers or seals including but not limited a rubber washer, an O-ring, or a gasket made of various materials.

12. Toilet system attached a multi-purpose hand held water sprayer according to claim 1 wherein said connection includes complete or partial components to achieve of delivering cold or tempered water to the sprayer.

13. Toilet system attached a multi-purpose hand held water sprayer according to claim 1 wherein said toilet system includes a conventional toilet system for the purpose of conventional toilet usage having a seat with a large opening for communication with the toilet bowl.
